(19) United States
(12) Patent Application Publication
(10) Pub. No.: US 2005/0068002 A1
(43) Pub. Date: Mar. 31, 2005

(54) Cell unit and power supply control method

(75) Inventor: Akihiro Ozeki, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/926,392

(22) Filed: Aug. 26, 2004

(30) Foreign Application Priority Data
Aug. 29, 2003 (JP) 2003-307590

(51) Int. Cl. H02M 1/00; H02J 7/00

(52) U.S. Cl. 320/101

(57) ABSTRACT

A cell unit includes a fuel cell capable of generating power by a chemical reaction, a secondary battery capable of being repetitively charged and discharged, a DC/DC converter which DC/DC-converts power output from the fuel cell and outputs power, the DC/DC converter monitoring an output voltage of a cell in the fuel cell and dropping an output voltage of the DC/DC converter when the monitored output voltage of the cell reaches not more than a predetermined value, and a diode OR circuit which selectively acquires power according to a load to which the power is supplied, from power output from the DC/DC converter and power output from the secondary battery, and outputs the acquired power.

### CROSS-REFERENCE TO RELATED APPLICATIONS

This application is based upon and claims the benefit of priority from prior Japanese Patent Application No. 2003-307590, filed Aug. 29, 2003, the entire contents of which are incorporated herein by reference.

### BACKGROUND OF THE INVENTION

1. Field of the Invention

The present invention relates to a cell unit having, e.g., a direct methanol type fuel cell, and a power supply control method.

2. Description of the Related Art

In recent years, various battery-driven portable electronic devices such as a portable information terminal (e.g., called a PDA: Personal Digital Assistant) and a digital camera have been developed and are widely spread.

Recently, environmental issues receive a great deal of attention, and environmentally friendly batteries have also actively been developed. A well-known battery of this type is a direct methanol fuel cell (to be referred to as a DMFC hereinafter).

The DMFC causes methanol and oxygen supplied as fuels to react with each other, and obtains electric energy from their chemical reaction. The DMFC has a structure in which two electrodes of a porous metal or carbon sandwich an electrolyte. In order not to generate any harmful waste, practical applications of the DMFC are strongly demanded.

The DMFC is equipped with accessories such as a liquid/air pump. In activating the DMFC, these accessories must be driven. For this purpose, the DMFC includes a secondary battery such as a lithium battery.

The rated output of the DMFC does not always coincide with the power consumption of an electronic device to which the power is supplied. For example, the electronic device may consume power more than the rated output of the DMFC. A technique which can cope with such situation is, e.g., Japanese Patent No. 2,717,215 (FIG. 1 and the like). This reference discloses “a fuel cell feeding system including a fuel cell, a DC/DC converter having a drop function of suppressing an output from the fuel cell within a predetermined value, and a DC power supply of another system which feeds a load device exceeding the rating of the fuel cell, wherein diodes for parallel operation are arranged in the DC/DC converter and the DC power supply of another system”.

According to the technique in this reference, a drop start point S in the DC/DC converter is set to a position corresponding to the value of the maximum rated output of the fuel cell. In some cases, almost the maximum rated output state continues for a long time, causing a problem in the system or the like. To prevent this problem, demands have arisen for a technique of efficiently supplying power while ensuring safety.

### BRIEF SUMMARY OF THE INVENTION

Embodiments of the present invention may provide a cell unit and power supply control method capable of efficiently supplying power while ensuring safety.

According to one aspect of the present invention, there is provided a cell unit comprising: a fuel cell capable of generating power by a chemical reaction; a secondary battery capable of being charged and discharged; a DC/DC converter which DC/DC-converts power output from the fuel cell and outputs power, the DC/DC converter monitoring an output voltage of the fuel cell and dropping an output voltage of the DC/DC converter when the monitored output voltage of the fuel cell reaches not more than a predetermined value; and a diode OR circuit which selectively acquires power according to a load to which the power is supplied, from power output from the DC/DC converter and power output from the secondary battery, and outputs the acquired power.

According to another aspect of the present invention, there is provided a power supply control method applied to a cell unit including a fuel cell capable of generating power by a chemical reaction, a secondary battery capable of being charged and discharged, a DC/DC converter which DC/DC-converts power output from the fuel cell and outputs power, and a diode OR circuit which selectively acquires power according to a load to which the power is supplied, from power output from the DC/DC converter and power output from the secondary battery, and outputs the acquired power, the method comprising: monitoring an output voltage of a fuel cell in; and dropping an output voltage of the DC/DC converter when the monitored output voltage of the fuel cell reaches not more than a predetermined value.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the outer appearance of an electronic device system according to an embodiment of the present invention;

FIG. 2 is a block diagram showing the schematic arrangement of a fuel cell unit;

FIG. 3 is a block diagram showing another schematic arrangement of the fuel cell unit;

FIG. 4 is a block diagram showing the schematic arrangement of an electronic device;

FIG. 5 is a circuit diagram showing the arrange-ment of a supply control circuit 25 in FIGS. 2 and 3;

FIG. 6 is a graph for explaining the character-istic of a DC/DC converter;

FIG. 7 is a graph for explaining the character-istic of the DC/DC converter;

FIG. 8 is a graph showing the slope of the output voltage of the DC/DC converter;

FIG. 9 is a graph showing the output power of the DC/DC converter when a diode OR circuit is employed;

FIG. 10 is a graph showing a change in the output power of the DC/DC converter when the diode OR circuit is employed;

FIG. 11 is a graph for explaining another characteristic of the DC/DC converter;

FIG. 12 is a graph showing the voltage change of a secondary battery;

FIG. 13 is a block diagram showing an arrangement when the secondary battery is charged via the DC/DC converter; and

FIG. 14 is a graph for explaining the characteristics of a single cell and the DC/DC converter in charging when the system power supply is ON in the arrangement of FIG. 13.

### DETAILED DESCRIPTION OF THE INVENTION

Embodiments of the present invention will be described below with reference to the drawings.

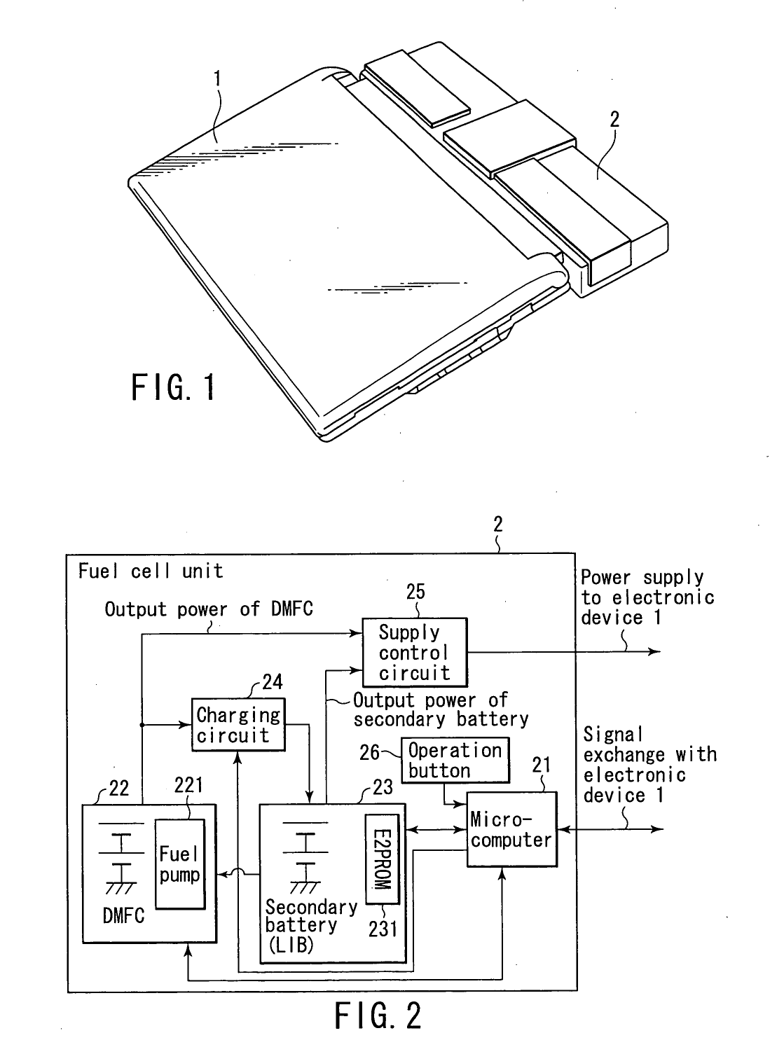

FIG. 1 is a perspective view showing the outer appearance of an electronic device system according to the embodiment of the present invention.

As shown in FIG. 1, the electronic device system according to the embodiment includes an electronic device 1, and a fuel cell unit 2 freely detachable from the electronic device 1. The electronic device 1 is, e.g., a notebook personal computer in which a lid having an LCD (Liquid Crystal Display) on its inner surface is attached to the main body by a hinge mechanism so as to be freely openable/closable. The electronic device 1 can operate by power supplied from the fuel cell unit 2. The fuel cell unit 2 incorporates a DMFC capable of generating power by a chemical reaction, and a secondary battery capable of being repetitively charged and discharged.

FIG. 2 is a block diagram showing the schematic arrangement of the fuel cell unit 2.

As shown in FIG. 2, the fuel cell unit 2 includes a microcomputer 21, DMFC 22, secondary battery 23, charging circuit 24, supply control circuit 25, and operation button 26.

The microcomputer 21 controls the operation of the whole fuel cell unit 2, and has a communication function of exchanging signals between the fuel cell unit 2 and the electronic device 1. The microcomputer 21 controls the operations of the DMFC 22 and secondary battery 23 in accordance with an instruction signal from the electronic device 1, and executes processing corresponding to a manipulation of the operation button 26.

The DMFC 22 allows attaching/detaching a cartridge type fuel tank 221. The DMFC 22 outputs power generated upon a chemical reaction between methanol contained in the fuel tank 221 and air (oxygen). This chemical reaction occurs in a reaction portion called a cell stack or the like. In order to efficiently feed methanol and air to the cell stack, the DMFC 22 includes an auxiliary mechanism such as a pump. The DMFC 22 has a mechanism of notifying the microcomputer 21 of mounting/non-mounting of the fuel tank 221, the amount of methanol left in the fuel tank 221, the operating status of the auxiliary mechanism, and the current output power amount.

The secondary battery 23 accumulates power output from the DMFC 22 via the charging circuit 24, and outputs the accumulated power in accordance with an instruction from the microcomputer 21. The secondary battery 23 includes an EEPROM 231 which holds basic information representing the discharging characteristic or the like. The EEPROM 231 can be accessed from the microcomputer 21, and the secondary battery 23 has a mechanism of notifying the microcomputer 21 of the current output voltage value and output current value. The microcomputer 21 calculates the remaining battery amount of the secondary battery 23 from basic information read out from the EEPROM 231 and the output voltage value and output current value sent from the secondary battery. The microcomputer 21 notifies the electronic device 1 of the calculated value. In this case, the secondary battery 23 is assumed to be a lithium battery (LIB).

The charging circuit 24 charges the secondary battery 23 by using power output from the DMFC 22. Whether to charge the secondary battery 23 or not is controlled by the microcomputer 21.

The supply control circuit 25 externally outputs power from the DMFC 22 and secondary battery 23 in accordance with the situation. This will be described in detail later.

The operation button 26 is a dedicated button for designating the operation stop of the DMFC 22 or entire fuel cell unit 2. The same function as the operation button may be implemented by a button provided by an application on the LCD screen of the electronic device 1, or may be implemented by holding the power button of the electronic device 1 down for a certain time (predetermined time or more).

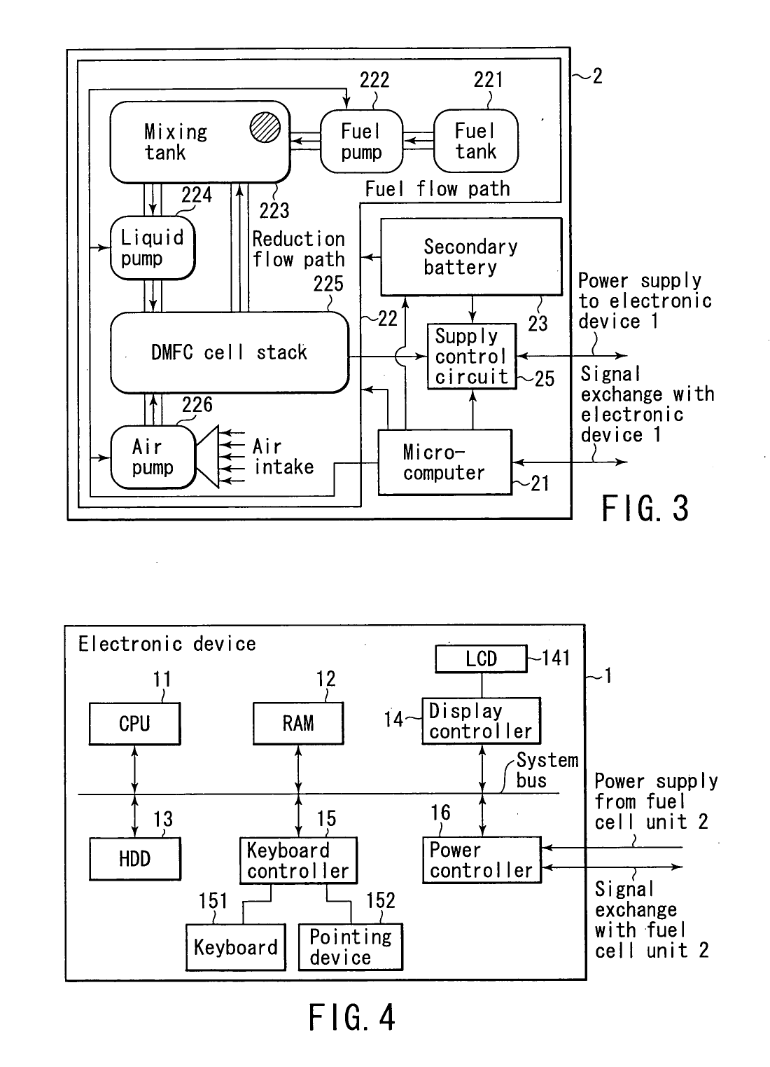

FIG. 3 is a block diagram showing another schematic arrangement of the fuel cell unit 2. The same reference numerals as in FIG. 2 denote the same parts.

As shown in FIG. 3, the DMFC 22 includes the fuel tank 221, a fuel pump 222, a mixing tank 223, a liquid pump 224, a DMFC cell stack 225, and an air pump 226.

The methanol in the fuel tank 221 is fed into the mixing tank 223 by the fuel pump 222. The methanol is also fed into the DMFC cell stack 225 by the liquid pump 224. Air is fed into the DMFC cell stack 225 by the air pump 226, and the oxygen in air and the methanol react with each other to generate power.

The microcomputer 21 controls to drive accessories such as the fuel pump 222, liquid pump 224, air pump 226, and fan by power from the secondary battery 23 in accordance with an activation instruction signal transmitted from the electronic device 1. Further, the microcomputer 21 controls the supply control circuit 25 so as to supply power output from the DMFC cell stack 225 or secondary battery 23 to the electronic device 1. The microcomputer 21 controls to charge the secondary battery 23 before the operation of the DMFC 22 stops in accordance with a stop instruction signal transmitted from the electronic device 1.

FIG. 4 is a block diagram showing the schematic arrangement of the electronic device 1.

As shown in FIG. 4, in the electronic device 1, a CPU 11, RAM (main memory) 12, HDD 13, display controller 14, keyboard controller 15, and power controller 16 are connected to a system bus.

The CPU 11 controls the operation of the whole electronic device 1, and executes various programs stored in the RAM 12. The RAM 12 is a memory device serving as the main memory of the electronic device 1. The RAM 12 stores various programs to be executed by the CPU 11 and various data used for these programs. The HDD 13 is a memory device serving as the external memory of the electronic device 1. As the auxiliary device of the RAM 12, the HDD 13 stores various programs and various data.

The display controller 14 controls the output side of the user interface in the electronic device 1. The display controller 14 controls to display image data created by the CPU 11 on an LCD 141. The keyboard controller 15 controls the input side of the user interface in the electronic device 1. The keyboard controller 15 converts a manipulation on a keyboard 151 or pointing device 152 into a numerical value, and transfers the numerical value to the CPU 11 via an internal register.

The power controller 16 controls power supply to each portion within the electronic device 1. The power controller 16 has a power reception function of receiving power supply from the fuel cell unit 2, and a communication function of exchanging signals between the electronic device 1 and the fuel cell unit 2. The partner in the fuel cell unit 2 that exchanges signals with the power controller 16 is the microcomputer 21 shown in FIGS. 2 and 3.

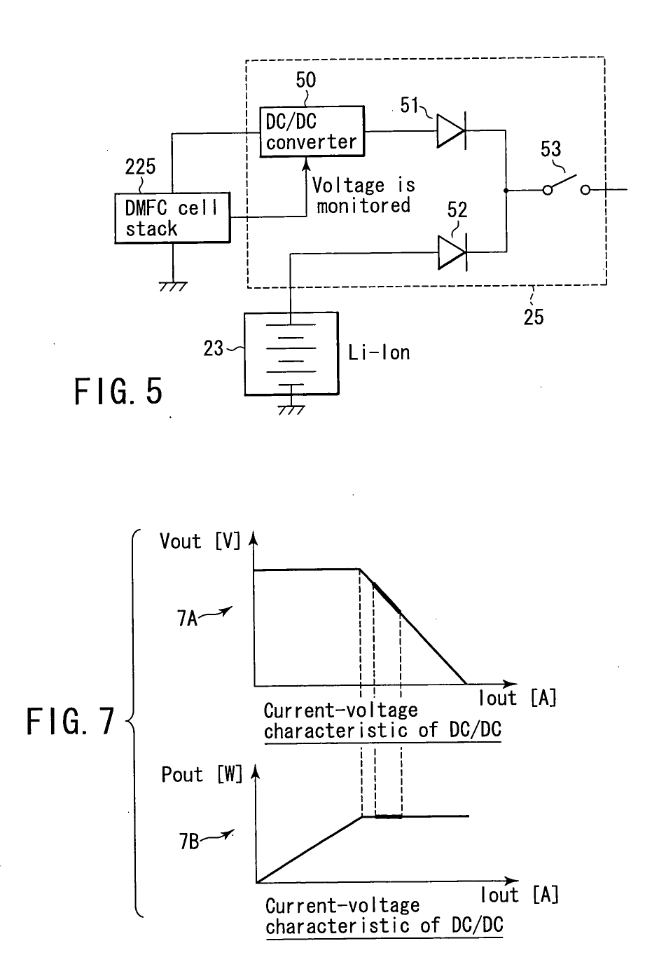

FIG. 5 is a circuit diagram showing the arrange-ment of the supply control circuit 25 in FIGS. 2 and 3.

The supply control circuit 25 includes a DC/DC converter (e.g., boosting DC/DC converter) 50, two diodes (rectifiers) 51 and 52, and a switch 53.

The DC/DC converter 50 includes a boosting circuit and the like. The DC/DC converter 50 DC/DC-converts power output from the DMFC cell stack 225, and outputs power. Especially, the DC/DC converter 50 monitors the output voltage of a single cell in the DMFC cell stack 225 (or cell stack), and when the monitored output voltage of the cell reaches a predetermined value (threshold) or less, drops the output voltage of the DC/DC converter. The predetermined value is slightly higher than a voltage value at the peak value of output power from a single cell. After the output voltage of the single cell reaches the predetermined value or less, the DC/DC converter 50 forms an output voltage which decreases along with an increase in output voltage, and forms predetermined output power regardless of an output current value.

A combination of the diodes 51 and 52 forms a diode OR circuit. This circuit selectively acquires power according to the load to which the power is supplied, from power output from the DC/DC converter 50 and power output from the secondary battery (LIB) 23, and outputs the acquired power.

The switch 53 is controlled by, e.g., the microcomputer 21 (FIGS. 2 and 3), and switches between supply/stop of power to a load device (in this case, the electronic device 1).

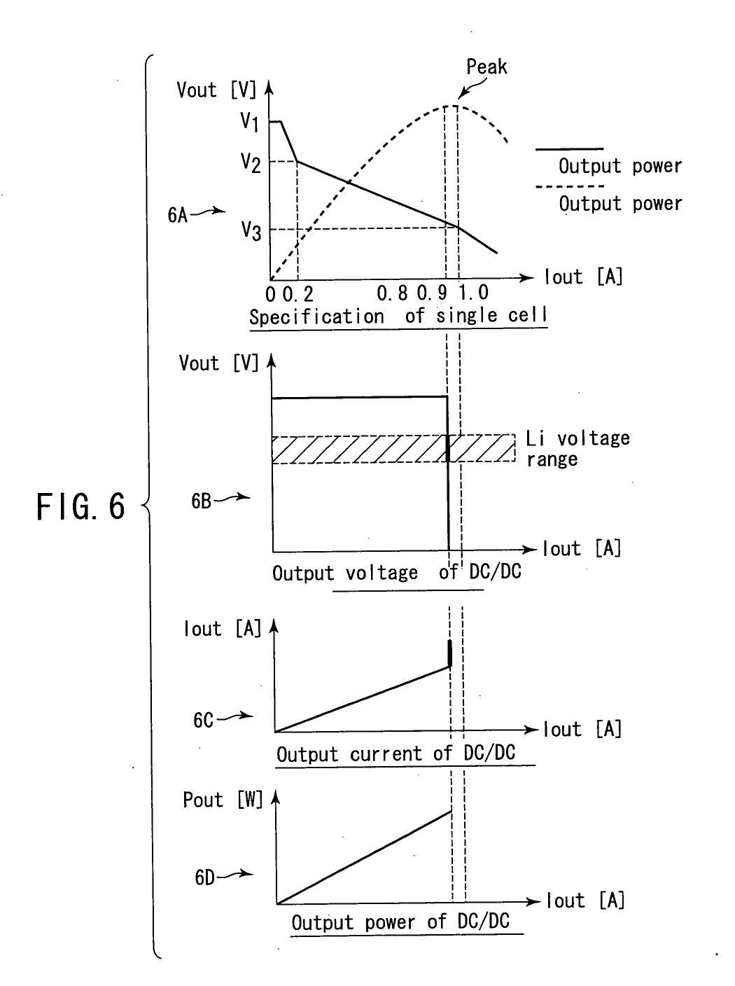

The characteristic of the DC/DC converter 50 will be explained with reference to FIG. 6.

A single cell for use in the DMFC cell stack 225 has the following specifications.
the voltage in the absence of any load=V1
the voltage drops to V2 or V3 in accordance with a load of 0.2 A to 1.0 A.
the power peak is 1.0 A.

The output voltage-output current characteristic of the single cell having these specifications is shown in a graph 6A of FIG. 6. This characteristic changes depending on the cell temperature or fuel concentration.

As shown in a graph 6B of FIG. 6, the output voltage of the DC/DC converter 50 is kept constant until the output current reaches 0.9 A (the output current at the cell terminal voltage is 0.9 A) (note that the output voltage is higher than the voltage range of the secondary battery 23). As shown in graphs 6C and 6D in FIG. 6, the output current and output power of the DC/DC converter 50 tend to increase. When the output current reaches 0.9 A (i.e., the output voltage of the single cell decreases to V3+α (α: dispersion)), the DC/DC converter 50 drops its output voltage, as represented by the graph 6B in FIG. 6.

If the cell output voltage reaches a predetermined value or less (V3 or less in FIG. 6), the device becomes abnormal. Thus, when the output voltage of a monitored single cell reaches a voltage value at the peak value of output power from the single cell, the DC/DC converter 50 shuts down by itself. If the output voltage of the single cell returns to a predetermined value or more after shutdown, the DC/DC converter 50 is reset under the control of the microcomputer (FIGS. 2 and 3). The DC/DC converter is reactivated to restart outputting power.

After the DC/DC converter 50 executes dropping of the output voltage, the output voltage drops along with an increase in an output current, as shown in a graph 7A of FIG. 7. The output power is kept constant, as represented by a graph 7B of FIG. 7.

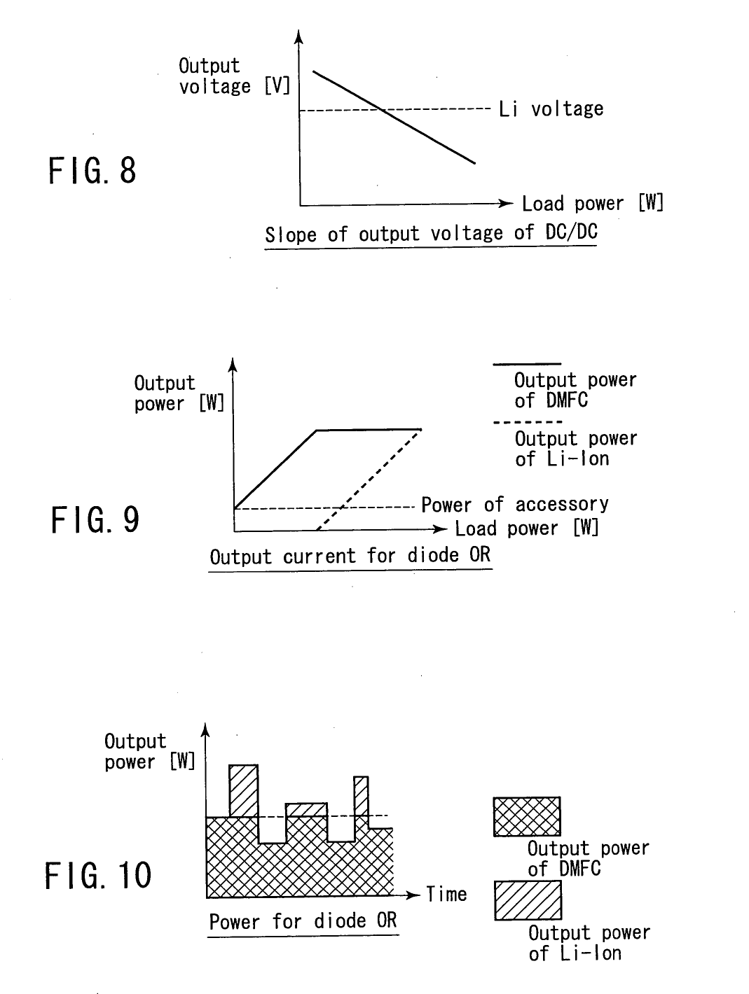

As shown in FIG. 8, the DC/DC converter 50 decreases the output voltage along with an increase in load power. If an output voltage for a rated output in the DMFC cell stack 225 is combined with the output voltage of the secondary battery 23, both the powers can be supplied via the diode OR circuit. In this case, as shown in FIG. 9, the output voltage of the DMFC cell stack 225 is kept constant, and the power of the DMFC cell stack 225 is effectively used, resulting in high efficiency. When power larger than the rated output of the DC/DC converter 50 is requested, not only the output power of the secondary battery 23 but also that of the DMFC cell stack 225 are efficiently used. This slows down a decrease in the remaining amount of the secondary battery 23.

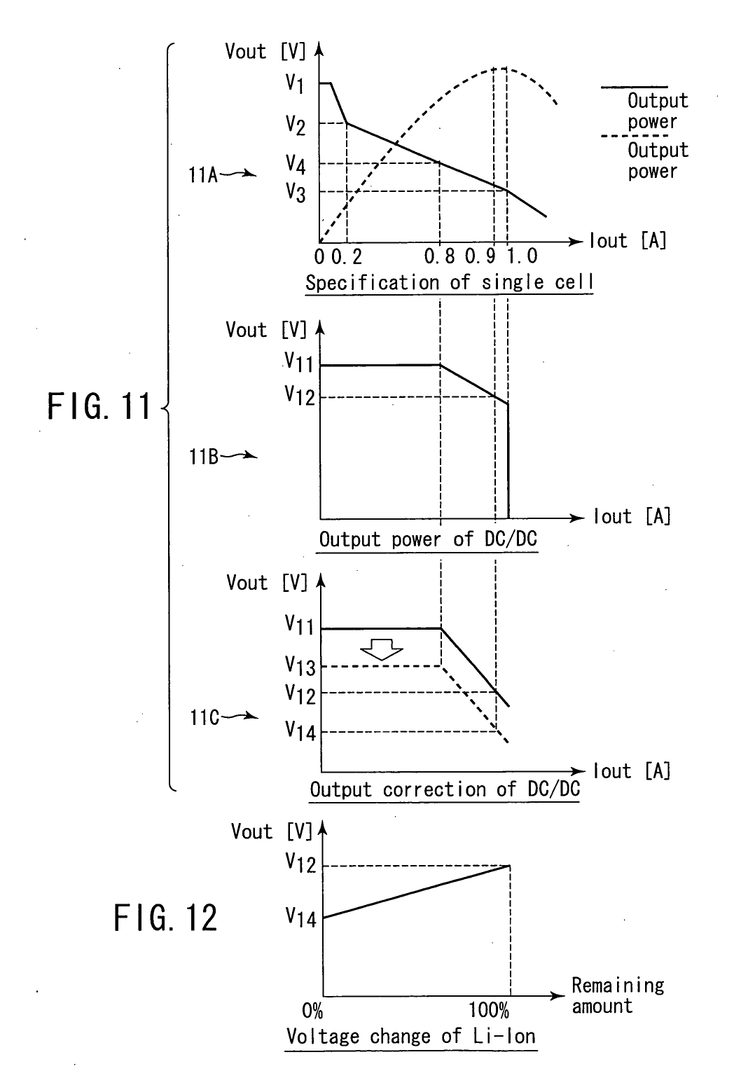

Another setting example for the characteristic of the DC/DC converter 50 will be explained with reference to FIG. 11.

Assume that a single cell in the DMFC cell stack 225 has an output voltage-output current characteristic as shown in a graph 11A of FIG. 11 (similar to the graph 6A in FIG. 6).

When the output voltage of a monitored single cell reaches V4 or less, the output voltage is multiplied by a predetermined multiple of the difference (by an offset voltage) to form a voltage slope as shown in a graph 11B of FIG. 11.

The output voltage of the DC/DC converter 50 is set equal to that of the secondary battery 23 at a single-cell output current of 0.9 A. In this example, the peak of output power from the single cell is 1.0 A, and a margin of 0.1 A is ensured. If the output current of the single cell exceeds 0.9 A, the DC/DC converter 50 shuts down.

As represented by a graph 11C of FIG. 11, the output voltage of the DC/DC converter 50 is properly corrected under the control of, e.g., the microcomputer 21 (FIGS. 2 and 3). Correction is necessary because the output voltage of the secondary battery changes in accordance with its remaining amount, as shown in FIG. 12.

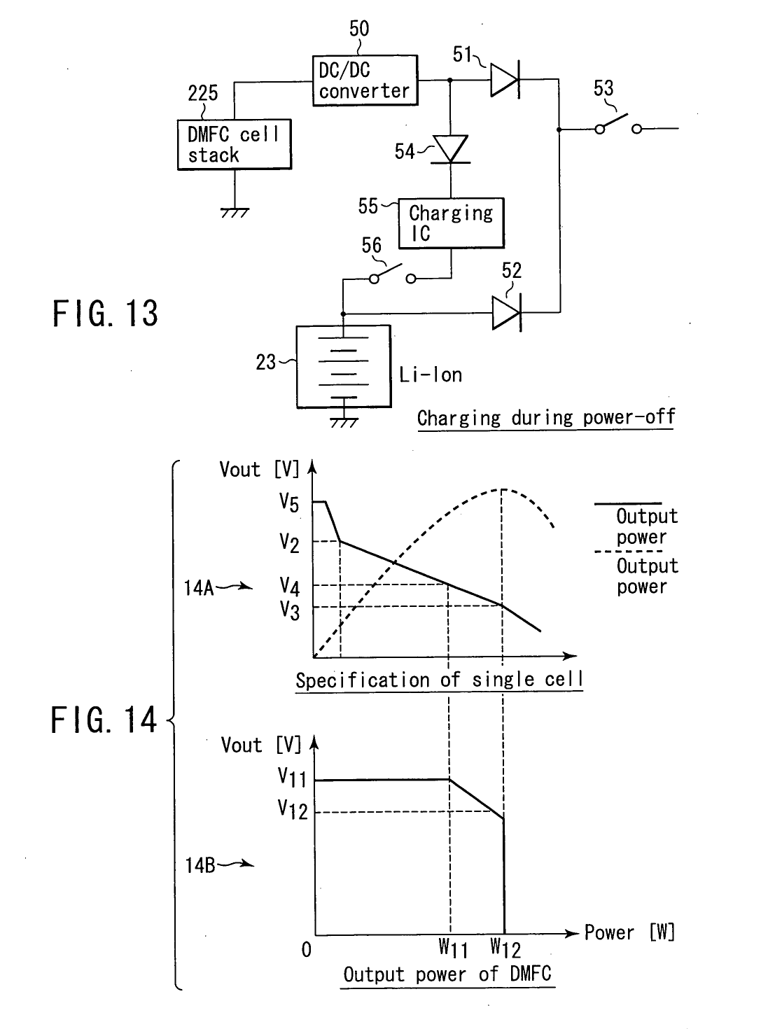

FIG. 13 is a block diagram showing an arrangement example when the secondary battery 23 is charged via the DC/DC converter 50. The same reference numerals as in FIG. 5 denote the same parts. As shown in FIG. 13, a diode 54, charging IC 55, and switch 56 are series-connected between the DC/DC converter 50 and the secondary battery 23. At this time, the system power supply is turned off, and the output voltage is fixed to, e.g., V11. In the DC/DC converter 50, the voltage slope and offset voltage are invalidated in turning off the system power supply.

FIG. 14 is a graph showing the characteristics of the single cell and DC/DC converter 50 in charging when the system power supply is ON in the arrangement of FIG. 13.

The characteristic of the single cell is shown in a graph 14A of FIG. 14. The characteristic of the DC/DC converter 50 is shown in a graph 14B of FIG. 14. In this example, the DC/DC converter 50 forms a voltage slope at power W11 or more and a cell voltage V4 or less. The DC/DC converter 50 limits power at W12 and the cell voltage V3. The minimum value of the charging current is 0.4 A. With these settings, charging starts when the output power of the DC/DC converter 50 is a preset value or less. Charging stops when the output power of the DC/DC converter 50 reaches W11 or less during charging.

In this manner, according to the embodiment, the supply control circuit adopts the diode OR circuit, and the DC/DC converter which monitors the output voltage of a single cell in the DMFC cell stack and drops the output voltage of the DC/DC converter when the output voltage of the cell reaches a predetermined value or less. Power can be efficiently supplied while safety is ensured.

As has been described above, the present invention can efficiently supply power while ensuring safety.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A cell unit comprising:
a fuel cell capable of generating power by a chemical reaction;
a secondary battery capable of being charged and discharged;
a DC/DC converter which DC/DC-converts power output from the fuel cell and outputs power, the DC/DC converter monitoring an output voltage of the fuel cell and dropping an output voltage of the DC/DC converter when the monitored output voltage of the fuel cell reaches not more than a predetermined value; and
a diode OR circuit which selectively acquires power according to a load to which the power is supplied, from power output from the DC/DC-converter and power output from the secondary battery, and outputs the acquired power.

2. The unit according to claim 1, wherein the predetermined value is higher than a voltage value at a peak value of output power of the fuel cell.

3. The unit according to claim 1, wherein the DC/DC converter forms an output voltage which decreases along with an increase in an output current after the monitored output voltage of the fuel cell reaches not more than the predetermined value.

4. The unit according to claim 1, wherein the DC/DC converter forms predetermined output power regardless of an output current value after the monitored output voltage of the fuel cell reaches not more than the predetermined value.

5. The unit according to claim 1, further comprising a circuit which corrects the output voltage of the DC/DC converter in accordance with at least a remaining amount of the secondary battery.

6. The unit according to claim 1, further comprising a controller which shuts down the DC/DC converter when the monitored output voltage of the fuel cell reaches a voltage value at a peak value of output power of the fuel cell.

7. The unit according to claim 6, wherein the controller reactivates the DC/DC converter and restarts output of power when the output voltage of the fuel cell returns to not less than a predetermined value after shutdown.

8. A power supply control method applied to a cell unit including a fuel cell capable of generating power by a chemical reaction, a secondary battery capable of being charged and discharged, a DC/DC converter which DC/DC-converts power output from the fuel cell and outputs power, and a diode OR circuit which selectively acquires power according to a load to which the power is supplied, from power output from the DC/DC converter and power output from the secondary battery, and outputs the acquired power, the method comprising:
monitoring an output voltage of a fuel cell in; and
dropping an output voltage of the DC/DC converter when the monitored output voltage of the fuel cell reaches not more than a predetermined value.

9. The method according to claim 8, wherein the predetermined value is higher than a voltage value at a peak value of output power of the fuel cell.

10. The method according to claim 8, wherein the DC/DC converter forms an output voltage which decreases along with an increase in an output current after the monitored output voltage of the fuel cell reaches not more than the predetermined value.

11. The method according to claim 8, wherein the DC/DC converter forms predetermined output power regardless of an output current value after the monitored output voltage of the fuel cell reaches not more than the predetermined value.

12. The method according to claim 8, wherein the output voltage of the DC/DC converter is corrected in accordance with at least a remaining amount of the secondary battery.

13. The method according to claim 8, wherein the DC/DC converter is shut down when the monitored output voltage of the fuel cell reaches a voltage value at a peak value of output power of the fuel cell.

14. The method according to claim 13, wherein the DC/DC converter is reactivated to restart output of power when the output voltage of the fuel cell returns to not less than a predetermined value after shutdown.

15. An electronic system including an electronic device and a cell unit comprising:
a fuel cell capable of generating power by a chemical reaction;
a secondary battery capable of being charged and discharged;
a DC/DC converter which DC/DC-converts power output from the fuel cell and outputs power, the DC/DC converter monitoring an output voltage of the fuel cell and dropping an output voltage of the DC/DC converter when the monitored output voltage of the fuel cell reaches not more than a predetermined value; and
a diode OR circuit which selectively acquires power according to a load to which the power is supplied, from power output from the DC/DC converter and power output from the secondary battery, and outputs the acquired power.

16. The system according to claim 15, wherein the predetermined value is higher than a voltage value at a peak value of output power of the fuel cell.

17. The system according to claim 16, wherein the DC/DC converter forms an output voltage which decreases along with an increase in an output current after the monitored output voltage of the fuel cell reaches not more than the predetermined value.

18. The system according to claim 17, wherein the DC/DC converter forms predetermined output power regardless of an output current value after the monitored output voltage of the fuel cell reaches not more than the predetermined value.

19. The system according to claim 17, further comprising a circuit which corrects the output voltage of the DC/DC converter in accordance with at least a remaining amount of the secondary battery.

20. The system according to claim 17, further comprising a controller which shuts down the DC/DC converter when the monitored output voltage of the fuel cell reaches a voltage value at a peak value of output power of the fuel cell.

21. The system according to claim 17, wherein the controller which reactivates the DC/DC converter and restarts output of power when the output voltage of the fuel cell returns to not less than a predetermined value after shutdown.
